(19) United States
(12) Patent Application Publication
(10) Pub. No.: US 2003/0220997 A1
(43) Pub. Date: Nov. 27, 2003

(54) Switched fabric based inspection system

(75) Inventors: Cory M. Watkins, Chanhassen, MN (US); Steven G. Palm, Minneapolis, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: August Technology Corp.

(21) Appl. No.: 10/424,143

(22) Filed: Apr. 25, 2003

Related U.S. Application Data
(60) Provisional application No. 60/375,365, filed on Apr. 25, 2002.
(60) Provisional application No. 60/375,517, filed on Apr. 25, 2002.
(60) Provisional application No. 60/375,487, filed on Apr. 25, 2002.

(51) Int. Cl. G06F 15/173

(52) U.S. Cl. 709/223; 709/201

(57) ABSTRACT

An inspection system is provided for performing high speed inspection. The system includes a data source, one or more computers for processing the data, and a switched fabric for data distribution to the one or more computers.

### CROSS REFERENCE TO RELATED APPLICATIONS

This application cross references and incorporates by reference U.S. Provisional Patent Application Nos. 60/375,365; 60/375,517 and 60/375,487, all filed on Apr. 25, 2002.

### BACKGROUND OF THE INVENTION

1. Technical Field

The present invention relates to methods and devices for acquiring and processing data over switched fabric networks.

2. Background Information

Over the past several decades, the microelectronics and semiconductor has exponentially grown in use and popularity. Microelectronics and semiconductors have in effect revolutionized society by introducing computers, electronic advances, and generally revolutionizing many previously difficult, expensive and/or time consuming mechanical processes into simplistic and quick electronic processes. This boom has been fueled by an insatiable desire by business and individuals for computers and electronics, and more particularly, faster, more advanced computers and electronics whether it be on an assembly line, on test equipment in a lab, on the personal computer at one's desk, or in the home via electronics and toys.

The manufacturers of microelectronics and semiconductors have made vast improvements in end product quality, speed and performance as well as in manufacturing process quality, speed and performance. However, there continues to be demand for faster, more reliable and higher performing semiconductors.

One process that has evolved over the past decade plus is the microelectronic and semiconductor inspection process. The merit in inspecting microelectronics and semiconductors throughout the manufacturing process is obvious in that bad wafers may be removed at the various steps rather than processed to completion only to find out a defect exists either by end inspection or by failure during use. In the beginning, wafers and like substrates were manually inspected such as by humans using microscopes. As the process has evolved, many different systems, devices, apparatus, and methods have been developed to automate this process such as the method developed by August Technology Corp. Many of these automated inspection systems, devices, apparatus, and methods focus on two or three dimensional inspection.

However, many one of the obstacles that continues to be an issue is speed of data transfer during inspection. The camera or sensor is imaging at very high rates of speed, and it has been found that in many cases today's computer technology and interconnections such as serial and parallel bus are not of sufficient speed and bandwith to keep up with the cameras and sensors.

In addition, currently, automatic inspection tools use custom boards for acquiring and distributing inspection data to processors, storage systems, and displays. These systems are expensive to develop and implement, require a workforce of people to maintain the design, and are typically not easily extendible as next generation computer components become available.

In addition in certain applications, dedicated hardware and systems are designed to process signal and image data at very high speeds. A standard distributed topology does not exist for processing this data. Custom designs are expensive, do not scale with innovations over time, are expensive to maintain.

### SUMMARY OF THE INVENTION

The present invention is an inspection system including a data source, one or more computers for processing the data, and a switched fabric for data distribution to the one or more computers.

### BRIEF DESCRIPTION OF THE DRAWINGS

Preferred embodiment of the invention, illustrative of the best mode in which applicant has contemplated applying the principles, are set forth in the following description and are shown in the drawings and are particularly and distinctly pointed out and set forth in the appended claims.

FIG. 1 is one embodiment of the present invention;

FIG. 2 is another embodiment of the present invention; and

FIG. 3 is a third embodiment of the present invention.

### DETAILED DESCRIPTION OF THE PREFERRED EMBODIMENT

The present invention is an improved inspection tool or system for use in a typical manufacture process such as a semiconductor or microelectronic manufacturing process. Automated inspection has become integral in these processes at many points including but not limited to at bare wafer, whole wafer, sawn wafer, and as the die are processed such as in waffle and/or gel packs or on substrates.

The present invention is an improved inspection tool or system using a novel approach to reducing cost, and adding extensibility. The system is an inspection tool based upon a switched fabric architecture such as InfiniBand, StarFabric, or PCI Express. A host computer would maintain motion control, digital and analog I/O, Serial I/O, and other low speed interfaces. The computer would link to a switched fabric network. The network would consist of one or more computers linked to the fabric switch for processing the data, a data source, and possibly a storage source.

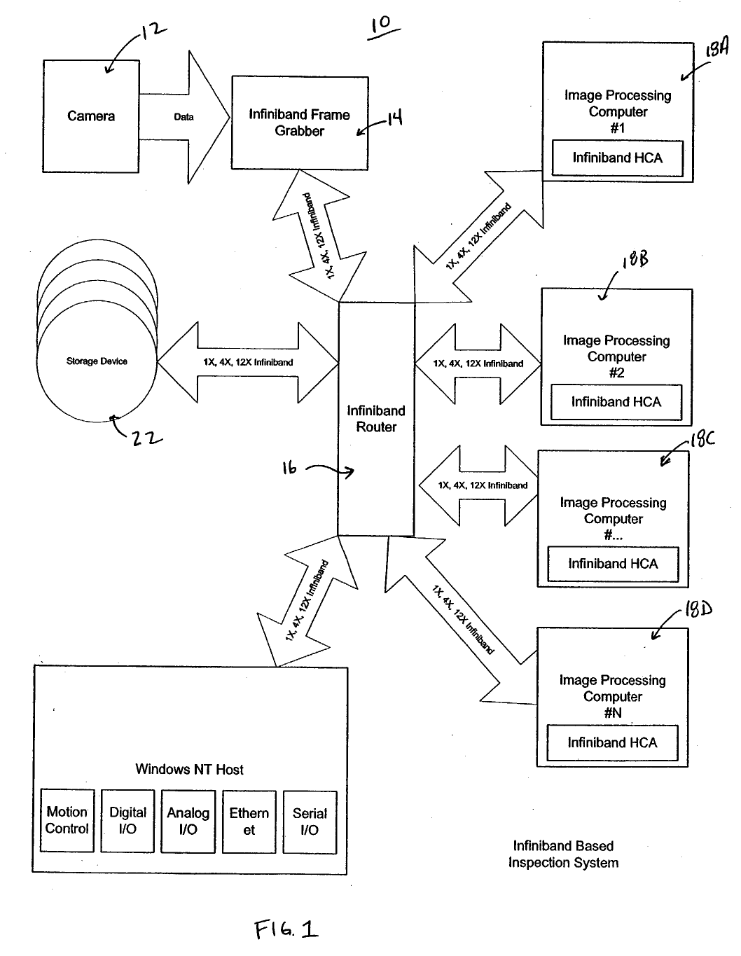

One embodiment of this system is shown in FIG. 1 as system 10. The system 10 includes a camera 12, a switched fabric network 14 such as an infiniband frame grabber, a switched fabric router 16 such as an infiniband router, one or more processors 18 such as image processing computers (18A, 18B, 18C, 18D) and an optional host system 20. The router 16 may also be connected to a storage device 22. In one version the image processing computers have infiniband HCA features, and the host system is a windows based NT host with at least one of motion control, digital I/O, analog I/O, Ethernet, and serial I/O incorporated therein.

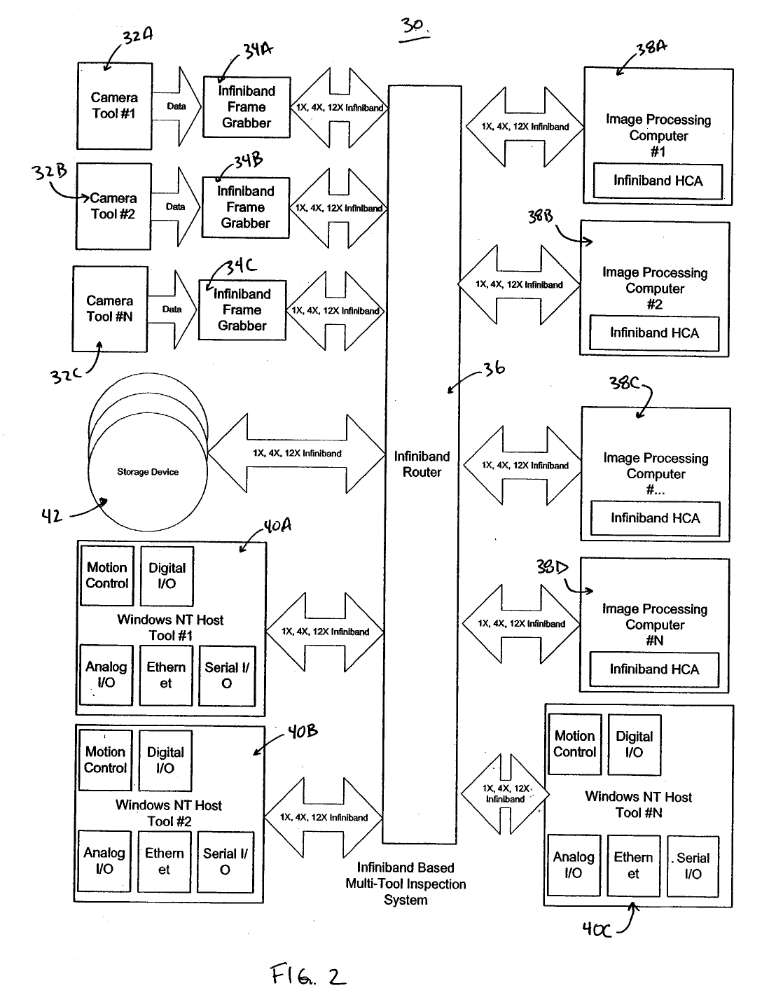

Another embodiment of the present invention incorporates the features above on multiple host computers. Each of the multiple host computers control their respective sensor or camera would contain motion control, digital and analog I/O, Serial I/O, and other low speed interfaces. A single cluster of one or more processing computers would process the data from one or more tools. One example is shown in FIG. 2 as system 30 includes multiple cameras 32A, 32B and 32C, a switched fabric network 34A, 34B and 34C such as an infiniband frame grabber for each camera, a switched fabric router 36 such as an infiniband router, one or more processors 38 such as image processing computers (38A, 38B, 38C, 38D) and a multiple host systems 40A, 40B and 40C. The router 36 may also be connected to a storage device 42. In one version the image processing computers have infiniband HCA features, and the host system is a windows based NT host with at least one of motion control, digital I/O, analog I/O, Ethernet, and serial I/O incorporated therein. This overall multiple host computer system will reduce cost of ownership for tools owners.

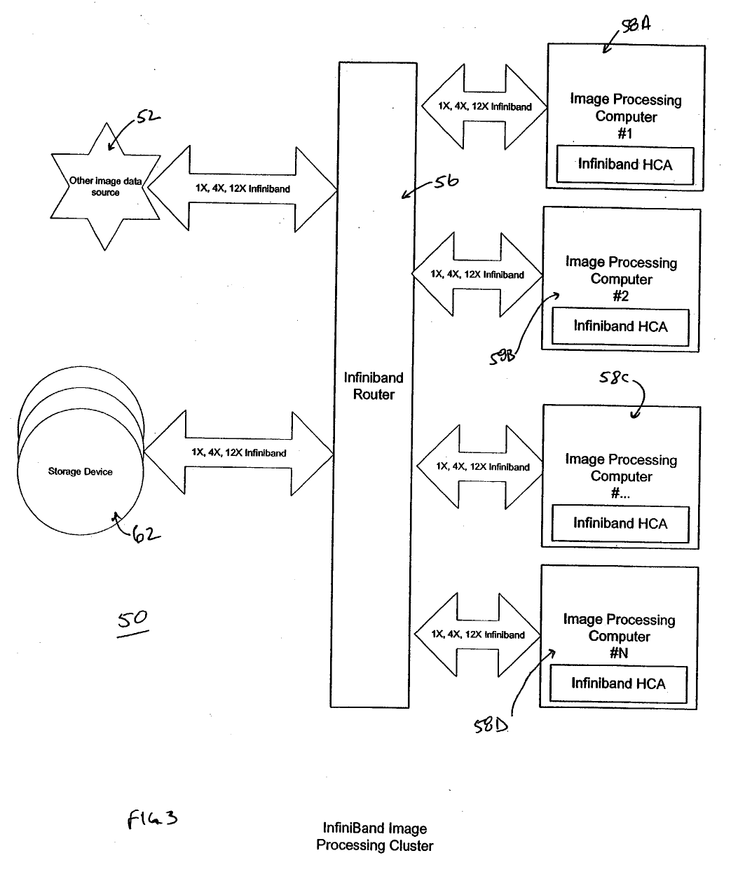

A third embodiment of the system is shown in FIG. 3 as system 50 and is a novel approach for image process clustering in a low cost setup. Basically the concept is that one or more processing computers could be linked via InfiniBand or other similar switched fabric network and used for processing the data streams from other devices. Furthermore, a storage system, Internet connection, and display could also be linked to the InfiniBand network. The benefits include low cost processing computers, ability to take advantage of the rapidly changing computer innovations, industry standard extensibility. In one example as is shown in FIG. 3 as system 50 includes an image data source 52, a switched fabric router 56 such as an infiniband router, and one or more processors 58 such as image processing computers (58A, 58B, 58C, 58D). The router 56 may also be connected to a storage device 62. In one version the image processing computers have infiniband HCA features.

Accordingly, the invention as described above and understood by one of skill in the art is simplified, provides an effective, safe, inexpensive, and efficient device, system and process which achieves all the enumerated objectives, provides for eliminating difficulties encountered with prior devices, systems and processes, and solves problems and obtains new results in the art.

In the foregoing description, certain terms have been used for brevity, clearness and understanding; but no unnecessary limitations are to be implied therefrom beyond the requirement of the prior art, because such terms are used for descriptive purposes and are intended to be broadly construed.

Moreover, the invention's description and illustration is by way of example, and the invention's scope is not limited to the exact details shown or described.

Having now described the features, discoveries and principles of the invention, the manner in which it is constructed and used, the characteristics of the construction, and the advantageous, new and useful results obtained; the new and useful structures, devices, elements, arrangements, parts and combinations, are set forth in the appended claims.

What is claimed is:

1. An inspection system comprising a data source, one or more computers for processing the data, and a switched fabric for data distribution to the one or more computers.

2. The inspection system of claim 1 further comprising a data storage mechanism linked via switched fabric.

3. The inspection system of claim 1 further comprising additional data sources.

4. An inspection system comprising a sensor, one or more computers for processing the data, and a switched fabric for data distribution to the one or more computers.

5. The inspection system of claim 4 further comprising a data storage mechanism linked via switched fabric.

6. The inspection system of claim 4 further comprising additional sensors.

7. An inspection system comprising a camera, one or more computers for processing the data, and a switched fabric for data distribution to the one or more computers.

8. The inspection system of claim 7 further comprising a data storage mechanism linked via switched fabric.

9. The inspection system of claim 1 further comprising additional cameras.

10. A signal processing system comprising an image data source, one or more computers for processing the data, and a switched fabric for data distribution to the one or more computers.

11. The signal processing system of claim 10 further comprising a data storage mechanism linked via switched fabric.

12. The signal processing system of claim 10 further comprising additional image data sources.

13. The signal processing system of claim 10 wherein the data distribution is via infiniband.

14. A signal processing system comprising an signal data source, one or more computers for processing the data, and a switched fabric for data distribution to the one or more computers.

15. The signal processing system of claim 10 further comprising a data storage mechanism linked via switched fabric.

16. The signal processing system of claim 10 further comprising additional signal data sources.

17. The signal processing system of claim 10 wherein the data distribution is via infiniband.
